(19) United States
(12) Patent Application Publication
(10) Pub. No.: US 2011/0080433 A1
(43) Pub. Date: Apr. 7, 2011

(54) Driver ic and organic light emitting diode display using the same

(76) Inventor: Sung-Cheon Park, Yongin-City (KR)

(21) Appl. No.: 12/801,370

(22) Filed: Jun. 4, 2010

(30) Foreign Application Priority Data
Oct. 7, 2009 (KR) 10-2009-0095025

(51) Int. Cl. G09G 3/32; G05F 5/00; G09G 5/00; G09G 5/10

(52) U.S. Cl. 345/690; 323/299; 345/212; 345/77

(57) ABSTRACT

A driver IC comprises a voltage detector configured to detect an input voltage to the driver IC, a charge pump configured to generate a regulator driving voltage by amplifying the input voltage and output the regulator driving voltage, a regulator configured to receive the regulator driving voltage and output a regulator voltage, a gamma circuit configured to generate a gray scale voltage using the regulator voltage, and a voltage controller configured to generate a command signal corresponding to the input voltage. An OLED display comprises a pixel unit configured to display an image in response to a data signal, a scan signal, a light emitting control signal, first and second voltages, the driver IC, a scan driving unit, and a power supply unit configured to adjust levels of the first and second voltages in response to the input voltage, and transmit the first and second voltages to the pixel unit.

### BACKGROUND

1. Field of the Invention

Embodiments relate to a driver IC and an organic light emitting diode display using the same, particularly a driver IC that adjusts a voltage of a data signal and a driving voltage in response to an input voltage, and an organic light emitting diode display using the driver IC.

2. Description of the Related Art

Weight and volume are disadvantages of cathode ray tubes. However, recently, various flat panel displays capable of reducing their weight and volume have been developed. The flat panel displays include liquid crystal displays, field emission displays, plasma display panels, and organic light emitting diode displays.

Among the flat panel displays, the organic light emitting diode displays display images using an organic light emitting diode that emits light by conjunction of electron holes and electrons generated in accordance with an electric current flow.

Since the organic light emitting diode displays have several advantages such as excellent color reproduction and small thickness, the market is largely expanding to the application fields of PDAs and MP3 players, etc. in addition to mobile phones.

FIG. 1 illustrates a schematic circuit diagram of a pixel commonly included in the organic light emitting diode displays. Referring to FIG. 1, a pixel may includes a first transistor M1, a second transistor M2, a capacitor Cst, and an organic light emitting diode OLED. The pixel is connected to a data line Dm and a scan line Sn.

In the first transistor M1, a source is connected to a first voltage ELVDD, a drain is connected to an anode electrode of the organic light emitting diode, and a gate is connected to a first node N1. In the second transistor M2, a source is connected the data line Dm, a drain is the first node N1, and a gate is connected to the scan line Sn. A first electrode and a second electrode of the capacitor Cst are connected to the first voltage ELVDD and the first node N1, respectively. An anode electrode and a cathode electrode of the organic light emitting diode are connected to the drain of the first transistor M1 and a second voltage ELVSS, respectively.

In the pixel having the above-described configuration, a voltage of the first node N1 is determined in response to a data signal transmitted through the data line Dm. The first transistor M1 allows an electric current to flow from the source connected to the first voltage ELVDD to the cathode of the organic light emitting diode connected to the second voltage ELVSS in accordance with the voltage of the first node N1. The organic light emitting diode emits light by this operation.

### SUMMARY

Embodiments are therefore directed to a driver IC that adjusts a voltage of a data signal and a driving voltage in response to an input voltage, and an organic light emitting diode display using the driver IC, which substantially overcome one or more of the problems due to the limitations and disadvantages of the related art.

It is therefore a feature of an embodiment to provide a driver IC, comprising: a voltage detector configured to detect an input voltage input to the driver IC; a charge pump configured to generate a regulator driving voltage by amplifying the input voltage and output the regulator driving voltage; a regulator configured to receive the regulator driving voltage and output a regulator voltage; a gamma circuit configured to generate a gray scale voltage using the regulator voltage; and a voltage controller configured to generate a command signal corresponding to the input voltage detected by the voltage detector.

The voltage detector may be further configured to generate a reference voltage and transmit the reference voltage to the regulator and the voltage controller.

The regulator may output the regulator voltage using the reference voltage and the regulator driving voltage.

The regulator may feed back the regulator voltage and compare the fed back regulator voltage with the reference voltage.

The voltage controller may generate the command signal using the reference voltage.

The regulator voltage may be lower than the regulator driving voltage.

The input voltage may be input from a battery.

It is therefore another feature of an embodiment to provide an organic light emitting diode display, comprising: a pixel unit configured to display an image in response to a data signal, a scan signal, a light emitting control signal, a first voltage, and a second voltage; a driver IC configured to generate the data signal and transmit the data signal to the pixel unit while generating a command signal corresponding to an input voltage input from the outside; a scan driving unit configured to generate the scan signal and the light emitting control signal and transmit the scan signal and the light emitting control signal to the pixel unit; and a power supply unit configured to adjust a level of the first voltage and a level of the second voltage in response to the input voltage, and transmit the first and second voltages to the pixel unit.

The driver IC may include a voltage detector configured to detect the input voltage input to the driver IC, a charge pump configured to generate a regulator driving voltage by amplifying the input voltage and output the regulator driving voltage, a regulator configured to receive the regulator driving voltage and output a regulator voltage, a gamma circuit configured to generate a gray scale voltage using the regulator voltage, and a voltage controller configured to generate the command signal corresponding to the input voltage detected by the voltage detector.

The voltage detector may be further configured to generate a reference voltage and transmit the reference voltage to the regulator and the voltage controller.

The regulator may output the regulator voltage using the reference voltage and the regulator driving voltage.

The regulator may feed back the regulator voltage and compare the fed back regulator voltage with the reference voltage.

The voltage controller may generate the command signal using the reference voltage.

The regulator voltage may be lower than the regulator driving voltage.

The input voltage may be input from a battery.

The power supply unit may include a first voltage generator configured to generate the first voltage by boosting the input voltage, and determine the voltage level of the first voltage in response to the command signal, and a second voltage generator configured to generate second voltage by inverting the input voltage, and determine the voltage level of the second voltage in response to the command signal.

The first voltage generator may be a boost circuit.

The second voltage generator may be a buck boost circuit.

By detecting the input voltage and controlling the voltages of a driving power source and a data signal in accordance with a change of the input voltage, power consumption may be reduced.

### BRIEF DESCRIPTION OF THE DRAWINGS

The above and other features and advantages will become more apparent to those of ordinary skill in the art by describing in detail exemplary embodiments with reference to the attached drawings, in which:

FIG. 1 illustrates a schematic circuit diagram of a pixel commonly included in an organic light emitting diode displays;

FIG. 2 illustrates a schematic block diagram of an organic light emitting diode display according to an exemplary embodiment;

FIG. 3 illustrates a schematic block diagram of an exemplary configuration of the driver IC illustrated in FIG. 2; and

FIG. 4 illustrates a schematic circuit diagram of an exemplary configuration of the power supply unit illustrated in FIG. 2.

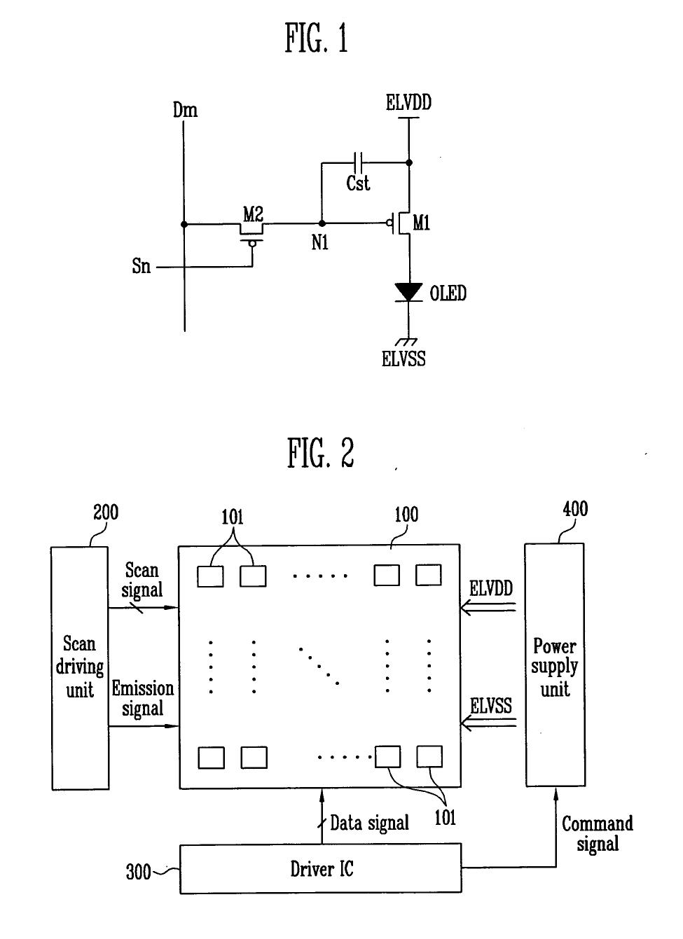

### DETAILED DESCRIPTION

Korean Patent Application No. 10-2009-0095025, filed on Oct. 7, 2009, in the Korean Intellectual Property Office, and entitled: “Driver IC and Organic Light Emitting Diode Display Using the Same” is incorporated by reference herein in its entirety.

Exemplary embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

FIG. 2 illustrates a schematic block diagram of a configuration of an organic light emitting diode display according to an exemplary embodiment. Referring to FIG. 2, the organic light emitting diode display may include a pixel unit 100, a scan driving unit 200, a driver IC 300, and a power supply unit 400.

A plurality of pixels 101 may be arranged in the pixel unit 100. Each of the pixels 101 may include an organic light emitting diode (not shown) which emits light in accordance with an electric current flow. Further, the pixel unit 100 may include n scan lines, and m data lines. Each of the n scan lines is arranged in a row direction to transmit a scan signal. Each of the m data lines is arranged in a column direction to transmit a data signal.

Further, the pixel unit 100 may be activated by receiving a first voltage ELVDD and a second voltage ELVSS. The pixel unit 100 may display an image by using the organic light emitting diode in each of the pixels 101. The organic light emitting diode may emit light when an electric current flows in response to a scan signal, a data signal, the first voltage ELVDD, and the second voltage ELVSS, etc. The first voltage ELVDD and the second voltage ELVSS are the driving voltages of the pixel unit 100.

The scan driving unit 200 is configured to generate scan signals. The scan driving unit 200 may transmit each scan signal to pixels 101 in a predetermined row of the pixel unit 100 through each scan line. The pixels 101 to which the scan signal is transmitted may receive a data signal outputted from the driver IC 300. A voltage corresponding to the data signal may be applied to the pixel 101.

The driver IC 300 is configured to generate a data signal. The driver IC 300 may generate a data signal using an image signal having red, blue, and green components. Further, the driver IC 300 may apply the data signal to the pixel unit 100 through a data line of the pixel unit 100. Furthermore, the driver IC 300 may generate a command signal.

The power supply unit 400 may receive an input voltage from the outside, and generate the first voltage ELVDD and the second voltage ELVSS. The power supply unit 400 may receive the command signal from the driver IC 300, and generate the first voltage ELVDD and the second voltage ELVSS using the command signal. In this operation, the power supply unit 400 may generate the first voltage ELVDD by boosting the command signal, and generate the second voltage ELVSS by inverting the command signal. The input voltage applied from the outside may be a voltage from a battery (not shown).

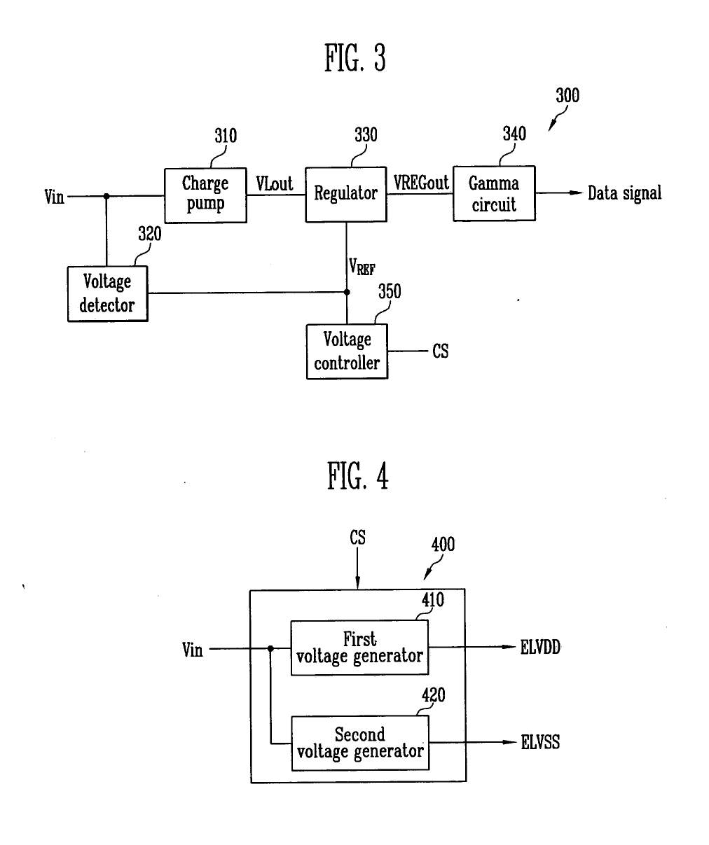

FIG. 3 illustrates a schematic block diagram of an exemplary configuration of the driver IC 300 illustrated in FIG. 2. Referring to FIG. 3, the driver IC 300 may include a charge pump 310, a voltage detector 320, a regulator 330, a gamma circuit 340, and a voltage controller 350.

The charge pump 310 may generate a regulator driving voltage VLout by receiving an input voltage Vin and amplifying the input voltage Vin. In general, the charge pump 310 may amplify the input voltage Vin to approximately two times.

The voltage detector 320 may detect a change of the input voltage Vin input from the outside. When the input voltage Vin is input from a battery, the input voltage Vin may gradually decrease in accordance with time of using the battery. Efficiency of the driver IC 300 and/or the power supply unit 400 may be decreased by a drop of the input voltage Vin. Therefore, the voltage detector 320 may detect the input voltage Vin to operate corresponding to a drop of the input voltage Vin. Further, the voltage detector 320 may generate a reference voltage V_{REF} and transmit the reference voltage V_{REF} to the regulator 330 and the voltage controller 350 corresponding to the detected voltage. Furthermore, the battery may output the input voltage Vin of 2.5 to 3.5V in accordance with a charged amount of the battery.

The regulator 330 may be used to ensure stability of a regulator driving voltage VLout outputted from the charge pump 310. The regulator 330 may output a regulator voltage VREGout using the reference voltage V_{REF} and the regulator driving voltage VLout. The regulator voltage VREGout may be set lower than the regulator driving voltage VLout outputted from the charge pump 310. Further, the regulator 330 may ensure stability of the regulator 330 by feeding back the regulator voltage VREGout and comparing the regulator voltage VREGout with the reference voltage V_{REF}. Furthermore, the reference voltage V_{REF} generated by the voltage detector 320 and the regulator driving voltage VLout outputted from the charge pump 310 may change in the regulator 330 in accordance with a change of the input voltage Vin. Therefore, the regulator voltage VREGout may change in accordance with the input voltage Vin.

The gamma circuit 340 may generate a gray scale voltage by receiving and distributing the regulator voltage VREGout. Further, the gamma circuit 340 may generate data signal using an input image signal and the gray scale voltage. In this operation, the regulator voltage VREGout may be changed in accordance with a change of the input voltage Vin. Therefore, the gray scale voltage of the data signal generated by the gamma circuit 340 may be changed in accordance with the input voltage Vin.

The voltage controller 350 may generate a command signal CS using the reference voltage V_{REF}. The voltage controller 350 may recognize the input reference voltage V_{REF}, and generate the command signal CS corresponding to the input reference voltage V_{REF}.

FIG. 4 illustrates a schematic diagram of an exemplary configuration of the power supply unit illustrated in FIG. 2. Referring to FIG. 4, the power supply unit 400 may include a first voltage generator 410 and a second voltage generator 420.

The first voltage generator 410 may receive the input voltage Vin, and generate the first voltage ELVDD. In this operation, the first voltage generator 410 may determine a voltage level of the first voltage ELVDD in response to the command signal CS outputted from the voltage controller 350. That is, the first voltage generator 410 may output the first voltage ELVDD by boosting the input voltage Vin. A voltage level of the first voltage ELVDD to be outputted from the first voltage generator 410 may be determined in response to the command signal CS. Further, the first voltage generator 410 may use a boost circuit.

The second voltage generator 420 may receive the input voltage Vin, and generate the second voltage ELVSS. In this operation, the second voltage generator 420 may determine a voltage level of the second voltage ELVSS in response to the command signal CS outputted from the voltage controller 350. That is, the second voltage generator 420 may generate the second voltage ELVSS by inverting the input voltage Vin, and the voltage level of the second voltage ELVSS outputted from the second voltage generator 420 may be determined in response to the command signal CS. Further, the second voltage generator 420 may use a buck boost circuit.

The boost circuit and the buck boost circuit are used for the first voltage generator 410 and the second voltage generator 420, respectively. The smaller the difference between the input voltage Vin and the output voltage, the larger efficiency of the boost circuit and the buck boost circuit. The input voltage Vin outputted from the battery may gradually decrease as time passes, and the input voltage may decrease while the output voltage is fixed. Therefore, the difference between the input voltage and the output voltage may gradually increase. Therefore, efficiency of the boost circuit and the buck boost circuit may decrease.

A boost circuit and an inverter circuit may respectively generate the first voltage ELVDD and the second voltage ELVSS that are applied to the pixel. Efficiency of the boost circuit and the inverter circuit decreases when a difference between an input voltage and an output voltage is large. Therefore, when the voltage of an electric current input from a battery decreases to a value lower than a predetermined value, the efficiency decreases. Consequently, the operation of the boost circuit and the inverter circuit may stop, and thus, a lifespan of the battery may be reduced.

In order to overcome this problem, the power supply unit 400 may determine the voltage levels of the first voltage ELVDD and the second voltage ELVSS using the command signal CS corresponding to a change of the input voltage Vin. Also, the power supply unit 400 may generate the first voltage ELVDD and the second voltage ELVSS by boosting or inverting the input voltage Vin. That is, the first voltage ELVDD and the second voltage ELVSS outputted from the first voltage generator 410 and the second voltage generator 420 in the power supply unit 400 may be controlled by the input voltage Vin such that efficiency of the power supply unit 400 may increase.

Further, the second voltage ELVSS may allow the organic light emitting diode to be activated in a saturation region. The saturation region may vary in accordance with material of an organic layer in the organic light emitting diode and the features of the first transistor for activating a pixel. Therefore, in designing an organic light emitting diode display, the second voltage ELVSS may be designed to have a voltage level margin of about 2 to 3V in order to display a desired image sufficiently even under bad conditions. Accordingly, in designing an organic light emitting diode display, an absolute level of the second voltage ELVSS may be designed to be large by fixing a level of the second voltage ELVSS. When the absolute level of the second voltage ELVSS is designed to be large (e.g. −5.4V), a voltage level of an electric current input from the battery may be designed to be large. However, when the level of the second voltage ELVSS is designed to be controlled by the input voltage Vin, it is not necessary to design the level of the second voltage ELVSS to be large to increase efficiency of the power supply unit 400.

Exemplary embodiments have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the invention as set forth in the following claims.

What is claimed is:

1. A driver IC, comprising:
a voltage detector configured to detect an input voltage input to the driver IC;
a charge pump configured to generate a regulator driving voltage by amplifying the input voltage and output the regulator driving voltage;
a regulator configured to receive the regulator driving voltage and output a regulator voltage;
a gamma circuit configured to generate a gray scale voltage using the regulator voltage; and
a voltage controller configured to generate a command signal corresponding to the input voltage detected by the voltage detector.

2. The driver IC as claimed in claim 1, wherein the voltage detector is further configured to generate a reference voltage and transmit the reference voltage to the regulator and the voltage controller.

3. The driver IC as claimed in claim 2, wherein the regulator outputs the regulator voltage using the reference voltage and the regulator driving voltage.

4. The driver IC as claimed in claim 2, wherein the regulator feeds back the regulator voltage and compares the fed back regulator voltage with the reference voltage.

5. The driver IC as claimed in claim 2, wherein the voltage controller generates the command signal using the reference voltage.

6. The driver IC as claimed in claim 1, wherein the regulator voltage is lower than the regulator driving voltage.

7. The driver IC as claimed in claim 1, wherein the input voltage is input from a battery.

8. An organic light emitting diode display, comprising:
a pixel unit configured to display an image in response to a data signal, a scan signal, a light emitting control signal, a first voltage, and a second voltage;
a driver IC configured to generate the data signal and transmit the data signal to the pixel unit while generating a command signal corresponding to an input voltage input from the outside;
a scan driving unit configured to generate the scan signal and the light emitting control signal and transmit the scan signal and the light emitting control signal to the pixel unit; and
a power supply unit configured to adjust a level of the first voltage and a level of the second voltage in response to the input voltage, and transmit the first and second voltages to the pixel unit.

9. The organic light emitting diode display as claimed in claim 8, wherein the driver IC includes
a voltage detector configured to detect the input voltage input to the driver IC,
a charge pump configured to generate a regulator driving voltage by amplifying the input voltage and output the regulator driving voltage,
a regulator configured to receive the regulator driving voltage and output a regulator voltage,
a gamma circuit configured to generate a gray scale voltage using the regulator voltage, and
a voltage controller configured to generate the command signal corresponding to the input voltage detected by the voltage detector.

10. The organic light emitting diode display as claimed in claim 9, wherein the voltage detector is further configured to generate a reference voltage and transmit the reference voltage to the regulator and the voltage controller.

11. The organic light emitting diode display as claimed in claim 10, wherein the regulator outputs the regulator voltage using the reference voltage and the regulator driving voltage.

12. The organic light emitting diode display as claimed in claim 10, wherein the regulator feeds back the regulator voltage and compares the fed back regulator voltage with the reference voltage.

13. The organic light emitting diode display as claimed in claim 10, wherein the voltage controller generates the command signal using the reference voltage.

14. The organic light emitting diode display as claimed in claim 9, wherein the regulator voltage is lower than the regulator driving voltage.

15. The organic light emitting diode display as claimed in claim 9, wherein the input voltage is input from a battery.

16. The organic light emitting diode display as claimed in claim 8, wherein the power supply unit includes
a first voltage generator configured to generate the first voltage by boosting the input voltage, and determine the voltage level of the first voltage in response to the command signal, and
a second voltage generator configured to generate second voltage by inverting the input voltage, and determine the voltage level of the second voltage in response to the command signal.

17. The organic light emitting diode display as claimed in claim 16, wherein the first voltage generator is a boost circuit.

18. The organic light emitting diode display as claimed in claim 16, wherein the second voltage generator is a buck boost circuit.
